(19) United States
(12) Patent Application Publication
(10) Pub. No.: US 2024/0295229 A1
(43) Pub. Date: Sep. 5, 2024

(54) Hydraulic Cylinder with Sequence Valve System and Method

(71) Applicant: Milwaukee Electric Tool Corporation, Brookfield, WI (US)

(72) Inventor: Mathew R. Rentmeester, Wauwatosa, WI (US)

(21) Appl. No.: 18/592,384

(22) Filed: Feb. 29, 2024

Related U.S. Application Data
(60) Provisional application No. 63/488,291, filed on Mar. 3, 2023.

(51) Int. Cl. F15B 21/00; F15B 11/08; F15B 15/14

(52) U.S. Cl. CPC F15B 21/001; F15B 11/08; F15B 15/14

(57) ABSTRACT

A hydraulic cylinder system and method for operating the hydraulic cylinder system for a hydraulic tool is provided. The hydraulic cylinder system comprises an inner hydraulic cylinder, an outer hydraulic cylinder, a hydraulic ram, a hydraulic pump, and a sequence valve embedded inside the hydraulic pump. The hydraulic pump provides flow into the inner hydraulic cylinder so that during operation of the hydraulic cylinder system, the hydraulic ram extends in a first phase, the sequence valve opens in a transition phase, and the hydraulic ram extends in a second phase.

### CROSS REFERENCE TO RELATED APPLICATIONS

This application claims priority to U.S. Provisional Patent Application No. 63/488,291 filed on Mar. 3, 2023, the entirety of which is incorporated by reference.

### BACKGROUND

Hydraulic cylinders are designed to move the individual parts of a tool by converting pressure into movement in linear motion. The cylinder includes a cylinder barrel, in which a piston connected to a piston rod moves back and forth. The piston divides the inside of the cylinder into two chambers, the bottom chamber (cap end) and the piston rod side chamber (rod end). The cylinders are powered by hydraulic pumps that convert pressure into movement by controlling the amount of fluid (e.g., hydraulic oil) that enters the chamber inside the hydraulic cylinder. The hydraulic pump brings in a fixed or regulated flow of fluid to the bottom side of the cylinder to move the piston rod upwards. Hydraulic cylinders are typically double-acting, which means that oil under pressure can be applied to either side of the piston to provide movement in either direction. Single-acting hydraulic cylinders use the weight of the load to return the cylinder to the closed position.

In hydraulic systems, sequence valves, which are pressure control valves, are used. Sequence valves are similar to pressure relief valves and are used where operations are to be controlled in a pressure-related sequence. A pressure relief valve is located on the outside of the hydraulic cylinders and is connected to the main hydraulic cylinder. When the hydraulic cylinder pressure drops below a predetermined level, the pressure relief valve opens and closes automatically, allowing fluid flow from one hydraulic cylinder to another. A sequence valve diverts fluid flow in a predetermined sequence with a spring chamber chain connected to a separate port. This allows a separate drain connection from the spring chamber and when the pressure rises above the limit, the sequence valve allows flow to occur in another part of the system.

However, there are certain perceived disadvantages to such known hydraulic tools. For example, the motor, hydraulic pump (e.g., one or more pump pistons), and gear assembly can often be complex, heavy, and bulky, particularly in hydraulic tools that are designed for high force applications due to the sequence valve being located outside of the hydraulic cylinders. In some cases, this can increase the cost to manufacture the hydraulic tool and might make the hydraulic tool more cumbersome for an operator to use.

### SUMMARY

There is a desire to provide a more compact hydraulic cylinder system with an embedded sequence valve inside a hydraulic pump of the hydraulic cylinder system that can be used for high force applications or lower force applications, and that is more user friendly to the operator.

In some embodiments of the disclosure, a hydraulic cylinder system is provided that includes an inner hydraulic cylinder inside an outer hydraulic cylinder and a hydraulic pump configured to provide fluid into the inner hydraulic cylinder. The hydraulic cylinder system also includes a hydraulic ram configured to extend to provide flow out of the outer hydraulic cylinder and a sequence valve embedded inside the hydraulic pump. During operation of the hydraulic cylinder system, the hydraulic cylinder system further includes a first phase, a transition phase, and a second phase.

Another embodiment of the disclosure provides a method of operating a hydraulic cylinder system including an inner hydraulic cylinder, an outer hydraulic cylinder, a hydraulic pump, a hydraulic ram, a sequence valve embedded inside the hydraulic pump, and a sequence spring. The method includes extending the hydraulic ram at a rate based on a pump flow rate of the hydraulic pump and an inner bore area of the hydraulic ram in a first phase, opening the sequence valve based on a relationship between a pressure of the inner hydraulic cylinder, a sequence area of the sequence valve and a force of the sequence spring in a transition phase, and extending the hydraulic ram at a rate based on the pump flow rate of the hydraulic pump and an outer annular area of the outer hydraulic cylinder in a second phase.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The accompanying drawings, which are incorporated in and form a part of this specification, illustrate embodiments of the disclosure and, together with the description, serve to explain the principles of embodiments of the disclosure.

FIG. 1 is a top view of a hydraulic cylinder system according to some embodiments of the disclosure;

FIG. 2 is a side view of the hydraulic cylinder system of FIG. 1;

FIG. 3 is an isometric view of the hydraulic cylinder system of FIG. 1;

FIG. 4 is a cross-section side view of the hydraulic cylinder system of FIG. 1;

FIG. 5 is a schematic illustration of an embedded sequence valve of a hydraulic cylinder system according to some embodiments of the disclosure;

FIG. 6 is a schematic illustration of the hydraulic cylinder system of FIG. 5 in a first phase according to some embodiments of the disclosure;

FIG. 7 is a schematic illustration of the hydraulic cylinder system of FIG. 5 in a transition phase according to some embodiments of the disclosure;

FIG. 8 is a schematic illustration of the hydraulic cylinder system of FIG. 5 in a second phase according to some embodiments of the disclosure; and

FIG. 9 is a flow diagram of a method of operating a hydraulic cylinder system according to some embodiments of the disclosure.

### DETAILED DESCRIPTION

The following discussion is presented to enable a person skilled in the art to make and use embodiments of the disclosure. Various modifications to the illustrated embodiments will be readily apparent to those skilled in the art, and the generic principles herein can be applied to other embodiments and applications without departing from embodiments of the disclosure. Thus, embodiments of the disclosure are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the disclosure. Skilled artisans will recognize the examples provided herein have many useful alternatives and fall within the scope of embodiments of the disclosure.

As used herein, unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Disclosed embodiments will now be described more fully hereinafter with reference to the accompanying drawings, in which some, but not all of the disclosed embodiments are shown. Indeed, several different embodiments may be provided and should not be construed as limited to the embodiments set forth herein. Rather, these embodiments are provided so that this disclosure will be thorough and complete and will fully convey the scope of the disclosure to those skilled in the art.

The disclosed hydraulic cylinder system will be described with respect to an example hydraulic tool. However, it should be understood that any one or more example embodiments of the disclosed hydraulic cylinder system could be incorporated in alternate forms of a hydraulic tool. Furthermore, it should be understood that one or more example embodiments of the disclosed hydraulic cylinder system could be used outside of the context of a pump system, and could more generally be used as a mechanism that generates reciprocation.

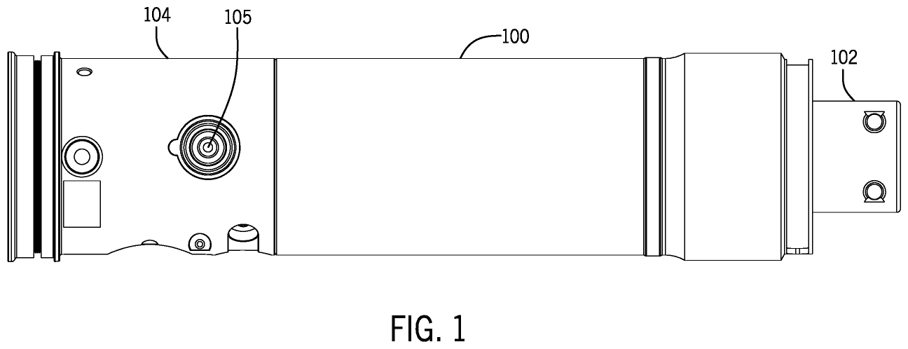

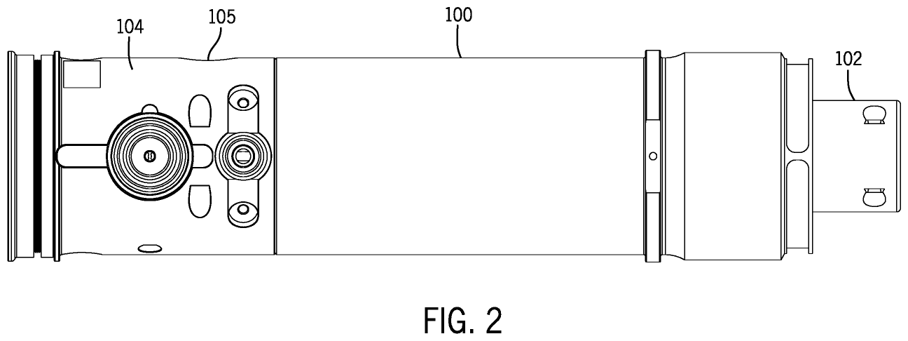

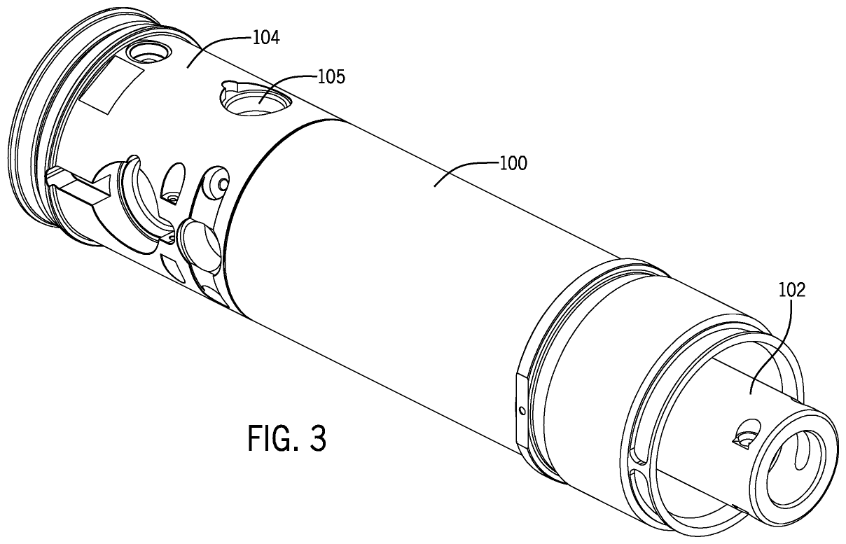

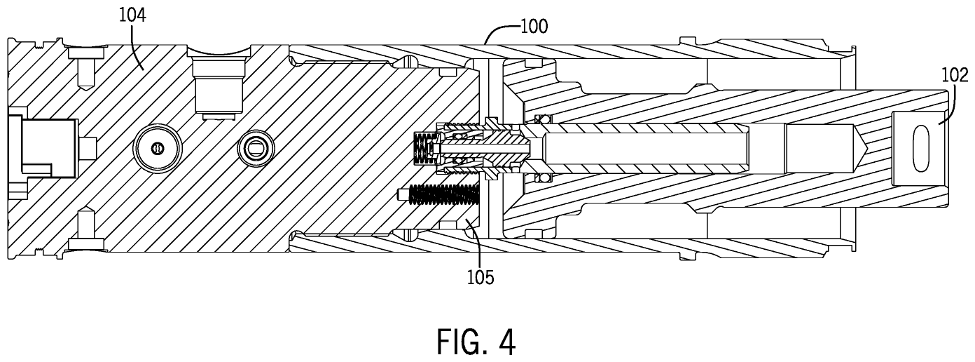

FIGS. 1-4 illustrate a hydraulic cylinder system 100 according to some embodiments of the disclosure. As shown in FIGS. 1-4, the hydraulic cylinder system 100 can include a hydraulic ram 102 extending from a first end of the system 100. A hydraulic pump 104 and a branch pipe 105 are located on a second end of the system 100.

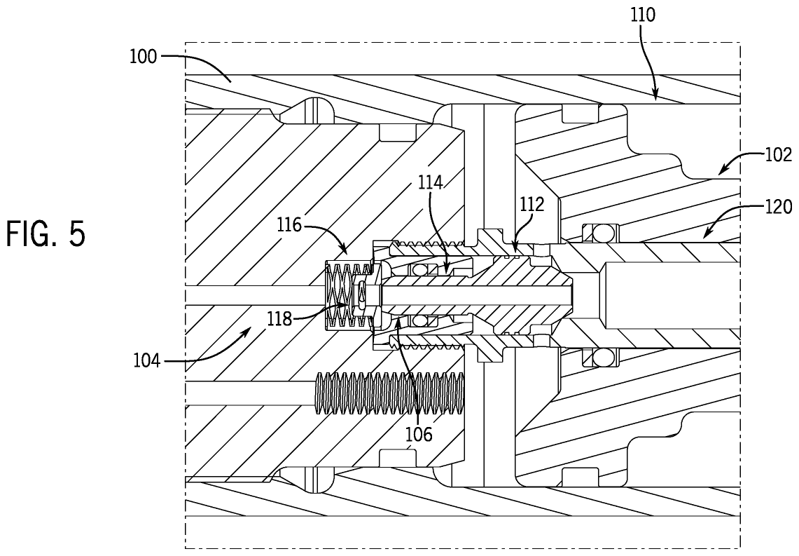

As shown in FIGS. 5-8, the hydraulic cylinder system 100 can further include a sequence valve 106, an inner hydraulic cylinder 120 inside the hydraulic ram 102 located within an outer hydraulic cylinder 110. The system 100 further includes a sequence poppet 112, a sequence cap 114, a sequence spring 116, and a sequence spring retainer 118.

FIG. 5 illustrates the sequence valve 106 embedded inside the hydraulic cylinder system 100 according to some embodiments. The hydraulic cylinder system 100 can include the hydraulic pump 104 in fluid communication with the inner hydraulic cylinder 120. The hydraulic cylinder system 100 can further include the hydraulic ram 102 configured to extend in an axial direction parallel to fluid flow to provide flow out of the outer hydraulic cylinder 110. The hydraulic cylinder system 100 can further include the sequence valve 106 embedded inside the hydraulic pump 104. During operation of the hydraulic cylinder system 100, the hydraulic cylinder system 100 operates according to a first phase 600, a transition phase 700, and a second phase 800.

In some embodiments, the outer hydraulic cylinder 110 can include an outer annular area. In other embodiments, the inner hydraulic cylinder 120 can include an inner annular area. The inner hydraulic cylinder 120 can further include an inner hydraulic cylinder pressure. Furthermore, the hydraulic ram 102 can include an inner bore area defined by an inner bore diameter of the hydraulic ram 102. The hydraulic pump 104 is configured to provide fluid into the inner hydraulic cylinder 120 and can provide fluid at a defined pump flow rate designated by a control system or an operator of the hydraulic cylinder system 100.

In some embodiments, the sequence valve 106 embedded inside the hydraulic pump 104 can include a sequence cap 114 configured to seal the sequence valve 106, a sequence poppet 112 in fluid communication with the hydraulic pump 104, a sequence spring 116 configured to act directly on the sequence poppet 112, and the sequence spring retainer 118 configured to hold and align the sequence spring 116 with the sequence valve 106. In some embodiments, the sequence valve can further include a sequence area in fluid communication with the inner annular area of the inner hydraulic cylinder 120. In other embodiments, the sequence poppet 112 can further include an inner annular area. In some embodiments, the sequence spring 116 can further include a spring force applied by the defined pump flow rate of the hydraulic pump 104.

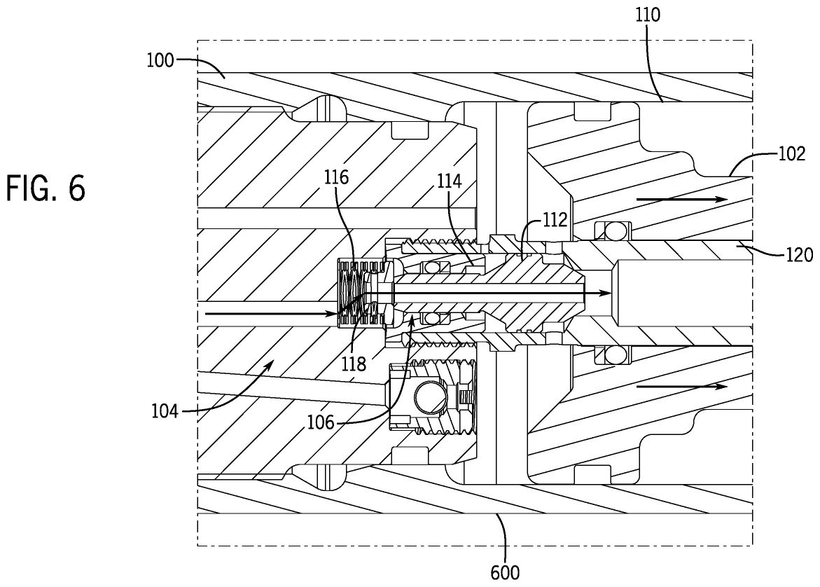

FIG. 6 illustrates the hydraulic cylinder system 100 in a first phase 600. In some embodiments, the first phase 600 can include a rapid ram extension phase, wherein the hydraulic ram 102 extends at a rate governed by the following relationship:

$$ExtensionRate ( \frac{in}{min} ) = \frac{PumpFlowRate ( \frac{{in}^{3}}{min} )}{{Area}_{RamInnerBore} ( {in}^{2} )}$$

In this relationship, PumpFlowRate is the defined pump flow rate of the hydraulic pump 104 designated by a control system or an operator of the hydraulic cylinder system 100, Area_{RamInnerBore} is the inner bore area of the hydraulic ram 102, and ExtensionRate is the rate which the hydraulic ram 102 extends defined by the pump flow rate and the area of the inner bore area of the hydraulic ram 102. In some embodiments, the hydraulic cylinder system 100 enters the rapid ram extension phase when flow from the hydraulic pump 104 moves through the inner annular area of the sequence poppet 112 and into the annular area of the inner hydraulic cylinder 120.

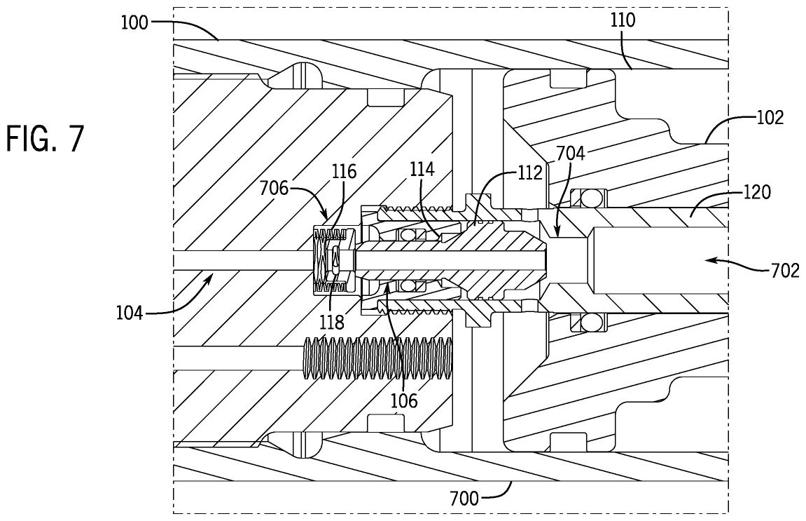

FIG. 7 illustrates the hydraulic cylinder system 100 in a transition phase 700. In some embodiments, the transition phase 700 can include a sequence valve transition phase, wherein the sequence valve 106 opens based on the following relationship:

P_{InnerCylinder}*A_{sequence}≥Force_{spring}

In this relationship, P_{InnerCylinder} is an inner hydraulic cylinder pressure 702 of the inner hydraulic cylinder 120, A_{sequence} is a sequence area 704 of the sequence valve between the inner hydraulic cylinder 120 and the sequence poppet 112, and Force_{spring} is a spring force 706 applied by the defined pump flow rate of the hydraulic pump 104. In some embodiments, the sequence valve 106 opens when the inner hydraulic cylinder pressure 702 exceeds a designed point after the first phase as dictated by the spring force 706 applied by the defined pump flow rate of the hydraulic pump 104.

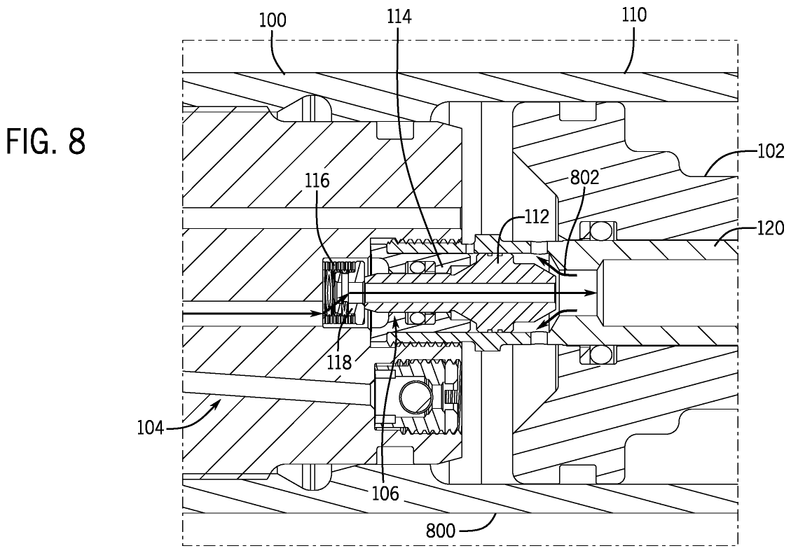

FIG. 8 illustrates the hydraulic cylinder system 100 in a second phase 800. In some embodiments, the second phase 800 can include a high force phase, wherein the hydraulic ram 102 extends at a rate governed by the following relationship:

$$ExtensionRate ( \frac{in}{min} ) = \frac{P u m p F l o w R a t e ( \frac{{in}^{3}}{min} )}{{Area}_{H y d r a u l i c C y l i n d e r} ( {in}^{2} )}$$

In this relationship, PumpFlowRate is the defined pump flow rate of the hydraulic pump 104 designated by a control system or an operator of the hydraulic cylinder system 100. Area_{HydraulicCylinder} is the outer annular area of the outer hydraulic cylinder 110 and ExtensionRate is the rate which the hydraulic ram 102 extends defined by the pump flow rate and the outer annular area of the outer hydraulic cylinder 110. In some embodiments, the hydraulic cylinder system 100 enters the high force phase after the sequence valve transition phase 700. For example, in some embodiments, after the sequence valve transition phase 700, flow from the hydraulic pump 104 moves through the inner annular area of the sequence poppet 112. As shown in FIG. 8, the sequence valve 106 opens and the flow from the hydraulic pump 104 bypasses the sequence poppet 112. Further, the flow from the hydraulic pump 104 is allowed to flow through annular openings 802 in the inner hydraulic cylinder 120 and flow to the outer hydraulic cylinder 110. This results in hydraulic pressure being applied to a larger area.

Additionally, the sequence valve 106 is closed during the first phase 600, so that flow from the hydraulic pump 104 moves only into the annular area of the inner hydraulic cylinder 120. In this relationship, the inner bore area of the hydraulic ram 102 is smaller than the outer annular area of the outer hydraulic cylinder 110 in the relationship of the second phase 800. A smaller inner bore area results in a rapid ram extension phase due to pressure being applied to a smaller area.

In contrast, the sequence valve 106 opens during the transition phase 700, so that flow from the hydraulic pump 104 moves into the annular area of the inner hydraulic cylinder 120 and the annular openings 802 in the inner hydraulic cylinder 120. Flow entering both the annular area and annular openings of the inner hydraulic cylinder 120 results in pressure being applied to a larger area in the second phase 800 compared to pressure being applied to only the inner bore area of the hydraulic ram 102 in the first phase 600. As seen in the relationship below, pressure being applied to the larger area in the second phase 800 results in a higher force as compared to pressure being applied to the smaller area in the first phase 600.

$$Pressure ( \frac{lb}{{in}^{2}} ) = \frac{Force ( lb )}{Area ( {in}^{2} )}$$

A larger area of the second phase 800, including the annular area of the inner hydraulic cylinder 120 and the annular openings 802 in the inner hydraulic cylinder 120, results in a high force phase as shown in the relationship above.

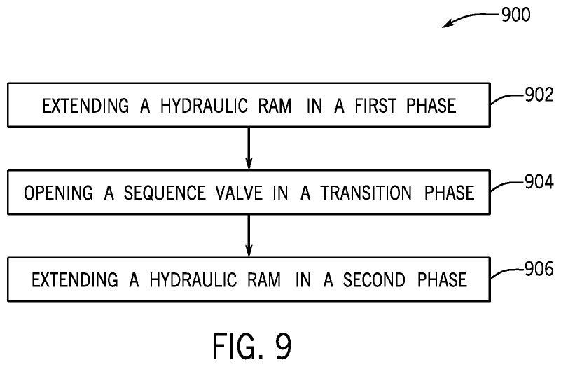

FIG. 9 illustrates one embodiment of a method 900 for operating a hydraulic cylinder system including an inner cylinder, an outer cylinder, a hydraulic pump, a hydraulic ram, a sequence valve embedded inside the hydraulic pump, and a sequence spring. While the method 900 is described with reference to the hydraulic cylinder system 100 discussed above, the method can also be used with other types of hydraulic cylinder systems. Additionally, in some cases, the method 900 may be implemented with other systems not explicitly described herein.

As illustrated in FIG. 9, the method 900 can include block 902 for extending the hydraulic ram 102 of the hydraulic cylinder system 100 at a rate based on a pump flow rate of the hydraulic pump 104 and an inner bore area of the hydraulic ram 102.

$$ExtensionRate ( \frac{in}{min} ) = \frac{PumpFlowRate ( \frac{{in}^{3}}{min} )}{{Area}_{RamInnerBore} ( {in}^{2} )}$$

The hydraulic ram 102 extends at the rate in a first phase (e.g., rapid ram extension phase) with the sequence valve 106 remaining closed during operation of the rapid ram extension phase.

In addition, as illustrated in FIG. 9, the method can further include block 904 for opening the sequence valve 106 of the hydraulic cylinder system 100 based on a relationship between a pressure of the inner hydraulic cylinder 120, a sequence area 704 of the sequence valve 106, and a spring force of the sequence spring 116.

P_{InnerCylinder}*A_{sequence}≥Force_{spring}

The sequence spring opens in a transition phase based on the relationship after the first phase (e.g., rapid ram extension phase), as shown in FIG. 7.

The method 900 can also include block 906 for extending the hydraulic ram 102 of the hydraulic cylinder system 100 at a rate based on a pump flow rate of the hydraulic pump 104 and an outer annular area of the outer hydraulic cylinder 110.

$$ExtensionRate ( \frac{in}{min} ) = \frac{P u m p F l o w R a t e ( \frac{{in}^{3}}{min} )}{{Area}_{H y d r a u l i c C y l i n d e r} ( {in}^{2} )}$$

The hydraulic ram 102 extends at the rate in a second phase (e.g., high force phase) with the sequence valve 106 open during operation of the high force phase. As shown in FIG. 8, the sequence valve 106 opens and the flow from the hydraulic pump 104 is allowed to flow through annular openings 802 and the annular area of the inner hydraulic cylinder 120 and flow to the outer hydraulic cylinder 110. Pressure being applied to a larger area results in the hydraulic ram 102 to extend at the rate in a high force phase.

By the term “about” or “substantially” with reference to amounts or measurement values described herein, it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The description of the different advantageous embodiments has been presented for purposes of illustration and description, and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A hydraulic cylinder system comprising:
an inner hydraulic cylinder inside an outer hydraulic cylinder;
a hydraulic pump to provide fluid into the inner hydraulic cylinder;
a hydraulic ram to extend to provide flow out of the outer hydraulic cylinder; and
a sequence valve embedded inside the hydraulic pump to operate the hydraulic pump according to a first phase, a transition phase, and a second phase.

2. The hydraulic cylinder system of claim 1, wherein the outer hydraulic cylinder comprises an outer annular area.

3. The hydraulic cylinder system of claim 1, wherein the inner hydraulic cylinder comprises an inner annular area.

4. The hydraulic cylinder system of claim 1, wherein the inner hydraulic cylinder provides an inner hydraulic cylinder pressure.

5. The hydraulic cylinder system of claim 1, wherein the hydraulic ram further comprises an inner bore area.

6. The hydraulic cylinder system of claim 1, wherein the hydraulic pump provides fluid at a defined pump flow rate.

7. The hydraulic cylinder system of claim 1, wherein the sequence valve comprises a sequence cap configured to seal the sequence valve.

8. The hydraulic cylinder system of claim 1, wherein the sequence valve comprises a sequence area in fluid communication with the inner annular area of the inner hydraulic cylinder.

9. The hydraulic cylinder system of claim 1, wherein the sequence valve comprises a sequence poppet in fluid communication with the hydraulic pump.

10. The hydraulic cylinder system of claim 9, wherein the sequence poppet comprises an inner annular area.

11. The hydraulic cylinder system of claim 1, wherein the sequence valve comprises a sequence spring configured to act directly on the sequence poppet.

12. The hydraulic cylinder system of claim 11, wherein the sequence spring provides a spring force applied by the hydraulic pump.

13. The hydraulic cylinder system of claim 1, wherein the sequence valve comprises a sequence spring retainer to hold and align the sequence spring with the sequence valve.

14. The hydraulic cylinder system of claim 1, wherein the first phase is defined by the hydraulic ram extending at a rate governed by a following relationship:
$$ExtensionRate ( \frac{in}{min} ) = \frac{PumpFlowRate ( \frac{{in}^{3}}{min} )}{{Area}_{RamInnerBore} ( {in}^{2} )}$$

15. The hydraulic cylinder system of claim 1, wherein the second phase is defined by the hydraulic ram extending at a rate governed by a following relationship:
$$ExtensionRate ( \frac{in}{min} ) = \frac{P u m p F l o w R a t e ( \frac{{in}^{3}}{min} )}{{Area}_{H y d r a u l i c C y l i n d e r} ( {in}^{2} )}$$
wherein an area of a hydraulic cylinder is the outer annular area.

16. The hydraulic cylinder system of claim 1, wherein the transition phase is defined by the sequence valve opening when the inner hydraulic cylinder pressure exceeds a designated point governed by a following relationship:
P_{InnerCylinder}*A_{sequence}≥Force_{spring}

17. A method of operating a hydraulic cylinder system, the method comprising:
extending a hydraulic ram at a rate based on a pump flow rate of a hydraulic pump and an inner bore area of the hydraulic ram in a first phase;
opening a sequence valve based on a relationship between a pressure of an inner cylinder, a sequence area of the sequence valve and a spring force of a sequence spring in a transition phase; and
extending the hydraulic ram at a rate based on the pump flow rate of the hydraulic pump and an outer annular area of an outer hydraulic cylinder in a second phase.

18. The method of claim 17, further comprising extending the hydraulic ram at the rate in the first phase defined by a following relationship:
$$ExtensionRate ( \frac{in}{min} ) = \frac{PumpFlowRate ( \frac{{in}^{3}}{min} )}{{Area}_{RamInnerBore} ( {in}^{2} )}$$

19. The method of claim 17, further comprising opening the sequence valve in the transition phase defined by a following relationship:
P_{InnerCylinder}*A_{sequence}≥Force_{spring}

20. The method of claim 17, further comprising extending the hydraulic ram at the rate in the second phase defined by a following relationship:
$$ExtensionRate ( \frac{in}{min} ) = \frac{P u m p F l o w R a t e ( \frac{{in}^{3}}{min} )}{{Area}_{H y d r a u l i c C y l i n d e r} ( {in}^{2} )}$$
wherein an area of a hydraulic cylinder is the outer annular area.
